(19) United States
(12) Patent Application Publication
(10) Pub. No.: US 2005/0286452 A1
(43) Pub. Date: Dec. 29, 2005

(54) Method and system for bi-directional exchange of data based on user-defined policies for the selection of a preferred datalink

(76) Inventors: Steve Hardgrave, Terenure (IE); Joe McGoldrick, Clontarf (IE); Bernard Hensey, Malahide (IE)

Correspondence Address: CARSTENS YEE & CAHOON, LLP, P O BOX 802334, DALLAS, TX, 75380, US

(21) Appl. No.: 11/130,790

(22) Filed: May 17, 2005

(30) Foreign Application Priority Data
May 18, 2004 (IE) S2004/0347

(51) Int. Cl. H04B 7/00

(52) U.S. Cl. 370/310

(57) ABSTRACT

A communications channel selection device aimed at solving the problems associated with selecting a preferred channel for two-way communication between an aircraft and the ground over TCP/IP packet-based networks. The device provides a means whereby policies for the selection of a preferred datalink are associated with the communications from aircraft-based applications so that communications are effected over the preferred channel according to a pre-defined set of policies. The device overcomes the challenges presented by the dynamic assignment of IP addresses to onboard systems by providing a method for: the discovery of dynamically assigned IP addresses (thereby enabling ground-initiated communications with an IP addressable entity) where such addresses relate to the preferred datalinks for active policies; queuing connect requests pending establishment of a connection to a ground-based system over a selected datalink; forwarding data over the selected datalink; mapping between the TCP/IP connection established and the connection over which the communicating application is communicating; defining policies such that they are understood by air-based and ground-based systems; a ground-based registry with which each onboard connecting application registers its currently preferred IP points of attachment for defined policies; a method for suitable authorised systems to retrieve the current IP address for a particular aircraft; and managing datalink connectivity.

### FIELD

The present application relates to the field of telecommunications and more particularly to methods of data communication with aircraft over different communications channels.

### BACKGROUND

Recent years have seen a proliferation in the number of different communications mechanisms that may be used to communicate between aircraft and the ground. Numerous datalink channels are now available from aircraft to ground and vice versa. The proliferation of wireless communications in recent years, together with the implementation of packet-based satellite communications channels, has led to an increase in the range and variety of communications datalinks available to onboard applications. The capability now exists to use such technologies, for example, as 802.11b/g, GPRS, Swift64 MPDS, and similar technologies to get data on and off the aircraft.

It is known from the prior art to make choices between the communications datalink to be used in communicating between aircraft and the ground. Most airlines have arrangements with numerous datalink service providers, and in order to minimise costs they have systems in their aircraft that select a particular service based on characteristics of the services such as cost, geography, and so on. These prior art systems typically choose between different communications links and/or service providers based on location of the aircraft, availability of a particular type of channel, (VHF, SATCOM, etc.), a user-defined hierarchy of preferred channels, or a user-defined preferred list of frequencies.

In short, the prior art permits the selection of the most economical communications link service provider and channel. The preferences are defined by the user and are usually contained in a database residing on the Communications Management Unit (CMU) on the aircraft. It will be appreciated that by their very nature, the preferences are only applied to downlink messages.

However, the use of packet-based networks brings its own challenges when considering choosing the optimum communications channel between aircraft and ground. To date, packet-based IP communications between an aircraft and ground have been largely ignored in terms of routing choice mechanisms. In instances where a TCP/IP connection is facilitated it is generally by a direct connection through a single communications channel, i.e. a computing device having an associated modem connection to a communications channel from the aircraft.

Accordingly, it would be an advantage if the TCP/IP communications could be extended to use a plurality of the available data connections available for ground to air communications.

### SUMMARY

The main embodiments are described in the claims which follow, however further embodiments are set out below and will also become apparent from the description and drawings which follow.

In one embodiment, a Connection Gateway is provided for an Aircraft, comprising
means for receiving requests from at least one application on the aircraft to transmit data over a TCP/IP connection from the aircraft,
a Policy table containing a list of Policies, each Policy having a ordered list of datalinks indicating the order of preference of the individual datalinks,
means for establishing TCP/IP connection using one of the plurality of different datalinks to one or more service providers, wherein said means for selecting a TCP/IP connection are adapted to determine the most appropriate datalink of currently available datalinks using the Policy associated with the application contained in the Policy table.

Once a TCP/IP connection has been established, all subsequent data passing between the connecting application and the remote application is suitably relayed to the corresponding connection within the Connection Gateway. Similarly, all data returning to the application on the aircraft from external applications is routed through the same connection.

The Connection Gateway suitably also comprises means for updating a datalink Point of Attachment Table in which a list of datalinks and their associated IP addresses is stored.

The Connection Gateway may also comprise means for informing an Aircraft Location Registry on the ground of its currently assigned IP addresses for different Policies.

The Connection Gateway may maintain a list of air-to-ground communications datalinks managed by it. This list may include additional information relating to one or more of the individual datalinks. This additional information may, for example, include the current status of each of the individual links. The Connection Gateway may also maintain a list of onboard applications using the Connection Gateway. This list may comprise a complete list of all on-board applications which may access the Connection Gateway or a shortened list of on-board applications currently (actively) connected to the Connection Gateway. The Connection Gateway may also store a list of mappings between the onboard applications and the communications datalinks which are allowed to be used by those applications and/or a record of the currently most preferred mapping for each application.

The Connection Gateway may be adapted to continuously monitor the status of all datalinks managed by it. The Connection Gateway may also be adapted to query individual datalinks for statistics regarding time connected, amount of data sent, errors, and so on.

The Connection Gateway may be further adapted to communicate information regarding its Policies to an application on the ground.

In another embodiment, an Aircraft Location Registry is provided, comprising a software application, running on a computing device, typically ground-based, which is adapted to receive information from an application on board an aircraft, said information identifying available communication Policies for the individual aircraft, wherein each available communication Policy has an associated IP address, wherein the Aircraft Location Registry is further adapted to associate this data with the aircraft in a data table for subsequent retrieval.

The data table of the Aircraft Location Registry may store ancillary information for one or more of the available communication Policies for an aircraft. This ancillary information may include the maximum permissible block size communicable for the Policy.

Another embodiment provides one or more onboard electronic devices, which have running on them one or more applications, communicating over TCP/IP, with an onboard Connection Gateway, which has the capacity to make a TCP/IP connection to one or more ground-based applications (hereinafter referred to in the singular, and by example, as “the server”), and/or manage connectivity over each of a number of air-to-ground communications datalinks.

In a further embodiment a datalink management system is provided wherein each connecting application connects to the Connection Gateway which in turn initiates a connection to the configured remote destination over the currently preferred datalink for that connecting application's associated communications Policy, based on a mapping between the address and TCP port of the connecting application. On successful establishment of the datalink connection, the Connection Gateway completes the connection to the connecting application. All subsequent data passing between the connecting application and the remote application (and vice versa) is then relayed to the corresponding connection within the Connection Gateway.

In a further embodiment, the Connection Gateway manages secure communications between the aircraft and the ground, such that onboard devices connecting through the Connection Gateway need not concern themselves with the establishment and maintenance of secure communications. This is achieved through the establishment of secure TCP/IP transport connections (for example SSL) over each available datalink managed by the Connection Gateway.

In a further embodiment a situation is created wherein both air-based and ground-based management software are aware of the communications Policies in operation, such that these Policies are shared between the air and the ground and as such decisions can be made regarding these Policies at either end of the communication.

In another embodiment, a datalink management system is provided whereby the Connection Gateway maintains
1. a list of air-to-ground communications datalinks managed by it, including their current status, along with a list of onboard applications connected to the Connection Gateway;
2. a list of mappings between the onboard applications and the communications datalinks which are allowed to be used by those applications; and
3. a record of the currently most preferred mapping for each application

In another embodiment, a route monitoring system is provided whereby the Connection Gateway is aware at all times about the status of all datalinks managed by it; and whereby the Connection Gateway can query datalinks for statistics regarding time connected, amount of data sent, errors, and so on.

In another embodiment, a communications mechanism is provided, whereby the response issued by the ground to a request made by the onboard application is automatically routed through to this application, such that at no time need the ground server be aware of the local address of the onboard device which initially connected to the Connection Gateway.

In a further embodiment, a communications mechanism is provided whereby Gateway is responsible for maintaining the liveliness of open connections through the periodic transmission of http ‘keepalive’ GET/POST primitives over the relevant TCP ground connections, and whereby systems remote to the aircraft can discover the liveliness of various datalinks through querying a Aircraft Location Registry, which contains, per communications Policy, the IP address which can be used to connect to an aircraft (and, by extension, the communications datalink which should be used), and which is updated whenever the communications datalinks become active/inactive.

In a further embodiment, a feature provides for the retention by the Connection Gateway, of an outstanding HTTP primitive on all open aircraft datalinks to the Aircraft Location Registry where such links are the preferred links of one or more active Policies, whereby the connections can be monitored and whereby a mechanism is provided for the Aircraft Location Registry to request the initiation of data transmission to the aircraft this avoiding the ground server having to wait until polled by the aircraft, before sending data to the aircraft.

A further embodiment provides for the retention, on the ground, by a ground based data manager (Ground Data Manager) of a list of the currently preferred IP addresses for all aircraft for a given Policy. This is realised through aircraft registering themselves with an Aircraft Location Registry, and updating their registration information when a successful connection is made over a given communications datalink. The Aircraft Location Registry is a ground-based list of all aircraft in a fleet, along with the IP addresses which can be used to communicate with the aircraft for the preferred datalink for all active communications Policies.

Another embodiment provides the ability, through a ground-based administrative management tool, to create and manage Policies which are to be associated with a given piece of data or an onboard application (based on source address, or destination address); whereby these Policies are used by the Connection Gateway when deciding which datalink to use when sending data.

Another embodiment may be considered to comprise an aircraft datalink management system, comprising one or more of the following features:
One or more software applications hosted on one or more electronic devices on board an aircraft;
Communicating over TCP/IP with an onboard Connection Gateway which is a software application acting as a manager controlling one or more datalink channels;
Being adapted to perform a method within the Connection Gateway for associating the local TCP port over which the communicating application has connected, with a Policy, containing an ordered list of datalink channels, to effect communications with an IP addressable entity;
Being adapted to perform a method for queuing of the connect request received from the connecting application pending the establishment of a connection over the selected data link to the destination associated with the connecting application as configured in the Connection Gateway.
Being adapted to perform a method for forwarding over the selected datalink by specifying the datalink's IP Point of Attachment as the TCP connection's source address and the configuration of a Policy Based Route in the IP stack's Routing Information Base.
Being adapted to perform a method for mapping between the TCP connection established over the datalink and the connection to the communicating application.
Being adapted to perform a method for defining Policies such that they are understood by air-based and ground-based systems.
A ground based Aircraft Location Registry with which each onboard Connection Gateway registers their currently preferred IP points of attachment for the defined Policies.
Being adapted to perform a method for the management of datalink connectivity status achieved by the exchange of HTTP GET/POST Request primitives between the onboard Connection Gateway and the Aircraft Location Registry
Being adapted to perform a method for the signalling of an aircraft via the issuing of a response to the said HTTP GET/POST request

A method for any suitably authorized system to retrieve from the Aircraft Location Registry the current IP address for a particular aircraft/Policy combination is also provided.

These and various other features of the embodiments of the present application will become apparent to those skilled in the art from the following description and corresponding drawings. It is submitted that the present application is capable of modification without departing from the scope and spirit of the application, and as such the descriptions and drawings supplied hereunder are seen as illustrative in nature, and not restrictive.

### BRIEF DESCRIPTION OF THE DRAWINGS

The present application will be described in conjunction with the following figures, wherein:

FIG. 1 shows a timeline illustrating the dynamic assignment of IP address to onboard systems as these systems log on and log off from different ISP networks in different parts of the world;

FIG. 2 shows an exemplary onboard communications representation, with a Communications Gateway being able to either receive or request notifications regarding the state of systems through which the datalinks are realised;

FIG. 3 shows an exemplary flowchart summarising Policy updating when a datalink becomes available;

FIG. 4 shows an exemplary flowchart summarising Policy updating when a datalink becomes unavailable;

FIG. 5 contains a summary depiction of the air-based and ground-based applications and their interaction through the system according to an embodiment of the present application;

FIG. 6 shows a depiction of a typical timeline fragment for the use of the outstanding GET/POST, according to an embodiment of the present application;

FIG. 7 shows a depiction of a timeline fragment showing how the system reacts to a datalink becoming no longer available.

FIG. 8 shows a schematic of an embodiment of the invention, and

FIG. 9 shows a schematic of another embodiment of the invention.

### DETAILED DESCRIPTION

The present application relates generally to the selection of communications channels for transfer of information onto and from an aircraft, and more particularly, to the ability of an aircraft communications management system to direct traffic over the most appropriate link for that traffic, taking into account datalink availability and suitability of the datalink for the type of data being transferred in packet-based Internet communications. By inference this suggests viewing the aircraft as a node on the Internet, utilising a knowledge, at application level, of the type of physical medium being used to connect to the Internet at point of attachment, and throughout the lifetime of the application.

This application relates to the selection of the most appropriate communications channel based on user-defined Policies. It facilitates the bi-directional synchronisation of electronic data sets residing on remote devices. The application has current application in the aviation industry where airlines wish to minimise their communications costs and maximise the value that they can derive from transferred data by Policy-based selection of the preferred communications channel. This is facilitated by the selection of the appropriate packet-based datalink (such as GPRS, 802.11b/g, Gatelink, and the Inmarsat Swift 64 MPDS satellite service) based on TCP/IP addressing information.

It is known for onboard applications to communicate with ground-based applications over an air to ground datalink. It is also known for onboard applications to use different datalinks including for example GPRS, 802.11b/g, Gatelink and Swift64 datalinks to transfer data from the air to the ground.

However, applications remote from the aircraft are unable to identify the IP address of a particular datalink (as explained below), thus the ability of an Internet-connected system, remote to an aircraft, to discover an aircraft's dynamically ascribed IP address for a particular datalink as described below represents an innovation in this field.

It will be appreciated that an aircraft attaches and de-attaches from the network at various stages during the flight segment. Conventionally, an aircraft is dynamically assigned an address when it attaches to a particular subnetwork associated with an Internet Service provider (ISP). Such addresses are dynamic in the sense that the service provider only assigns an address for this period of attachment. The addresses are not known in advance and do not typically span communication sessions. As a result ground systems (or potentially systems onboard other aircraft) wishing to initiate connectivity to aircraft which use dynamically assigned network addresses have no means of retrieving the aircraft address. However, one embodiment represents a further innovation in that it allows interested remote systems to discover these dynamically assigned addresses, optionally together with characteristics of the network connection. The network characteristics can include information regarding the network type, Swift64 MPDS, GPRS, IEEE802.11b and any other parameters that may be of use to the ground server in making a communication decision.

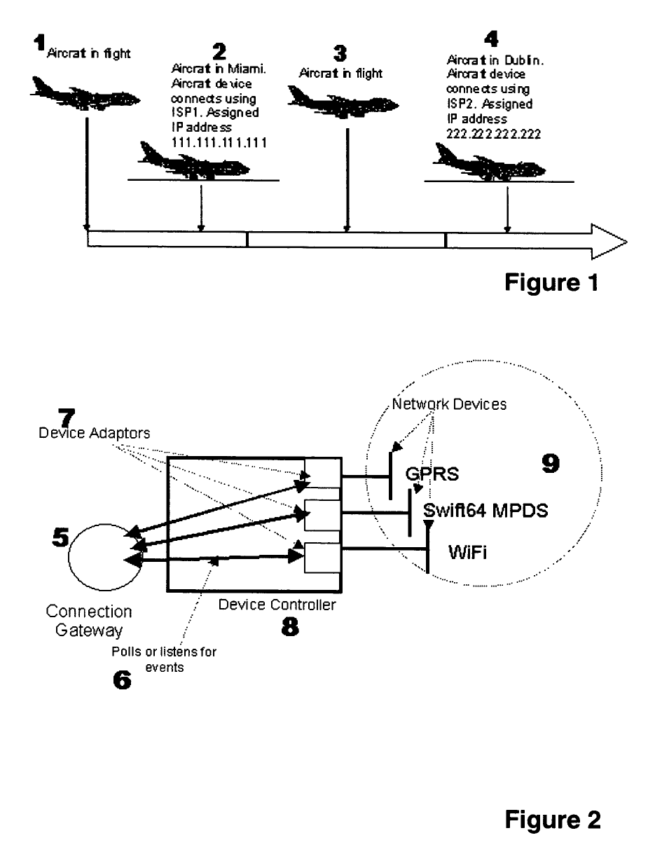

This dynamic IP address assignment is illustrated in FIG. 1, which shows a timeline covering the period where an aircraft is initially en route to Miami (1), the aircraft then lands at Miami (2). Upon landing, a communications device on board the aircraft connects to a GPRS service run by a first Internet service provider (ISP1). For this connection ISP1 issues the aircraft device with a particular IP address. (2) The aircraft takes off again (3) and flies to Dublin. Again, once in Dublin (4) a connection is made via GPRS, this time utilising the services provided by a second Internet service provider (ISP2). Once again a different IP address is issued to the aircraft device from ISP2's list of assignable IP addresses.

An aircraft may be seen as a transitory node on the Internet. The aircraft attaches to, and de-attaches from, the Internet at various points along its journey, according to such factors as geography, signal availability, service provider agreements, and so on. It is likely that for every connection made by an aircraft to the Internet, a different IP address would be assigned to the aircraft by the individual Internet service providers.

As discussed previously, there are numerous packet-based datalink channels available for aircraft-to-ground communications. Whenever an aircraft connects to, say for example, a GPRS endpoint, that aircraft may be assigned an IP address in the GPRS subnetwork. Simultaneously, that aircraft could be attached to a Swift64 MPDS base station, in which case an IP address on the Swift64 subnetwork may also be issued to that aircraft. This means that for each subnetwork over which the aircraft is connected to the Internet, the aircraft may have a separate IP address. Typically, Internet based communications are not concerned, at the application level, with the physical transport datalink used. However, the inventors of the present application have realised that when dealing with air-to-ground and ground-to-air communications, it is important to know what the physical transport datalink is. For example, a ground-based application might use knowledge of the transport datalink over which it is returning data to order the data that it returns to an air-based application. More fundamentally, a ground-based application may only be allowed to signal an aircraft over a given transport datalink. Thus a further challenge addressed by the present application is the need to know what physical datalink is being used for the transmission of air-to-ground, and ground-to-air data traffic. In addition, the inventors have realised that there is an associated need also to be able to discover attributes of that datalink, such as maximum data size, and so on.

In order to communicate with that aircraft, an application on the ground or in another aircraft needs to be aware of the aircraft's present IP address. Active aircraft IP addresses cannot, because of the dynamic nature of their assignment in packet-based networks, be known a priori. In order for an application, remote to the aircraft, to communicate with an aircraft, it must be possible for it to discover the aircraft's address on the subnetwork.

Another challenge addressed by the present application is that, whilst it is desirable for a remote application to be able to discover the IP address of an aircraft as it attaches to/de-attaches from a subnetwork, it is necessary to be able to limit what activities can be carried out with that knowledge. It is preferable that upon discovering the address of an aircraft, the ground-based system can make a request of the aircraft systems to initiate some form of communication that will enable the ground-based application to fulfil its function. The use of a signalling channel for a given communications Policy, to make well-known requests of the aircraft (by responding to an outstanding HTTP primitive as described below), represents a further innovation in that it enables ground-initiated communication without requiring the aircraft to operate as a server for incoming ground-initiated TCP connections.

The application will now be described with reference to some exemplary embodiments.

The embodiments of the present application are intended to facilitate the communication of data from one or more applications running on one or more electronic devices situated on board an aircraft to other electronic devices either on the ground or elsewhere e.g. in another aircraft. The one or more electronic devices on the aircraft are suitably networked, for example by means of an Ethernet LAN, using TCP/IP, to another electronic device termed herein as the Connection Gateway. The Connection Gateway may be suitably implemented in software code on a computing device having the necessary hardware (e.g. a network card, a WiFi (e.g. 802.11) card, and so on) for communicating with the various other networked devices on board the aircraft. It will be appreciated that a single computing device may be provided running the one or more applications including the Connection Gateway itself and containing the necessary hardware for communicating with application onboard the aircraft and ground-based applications.

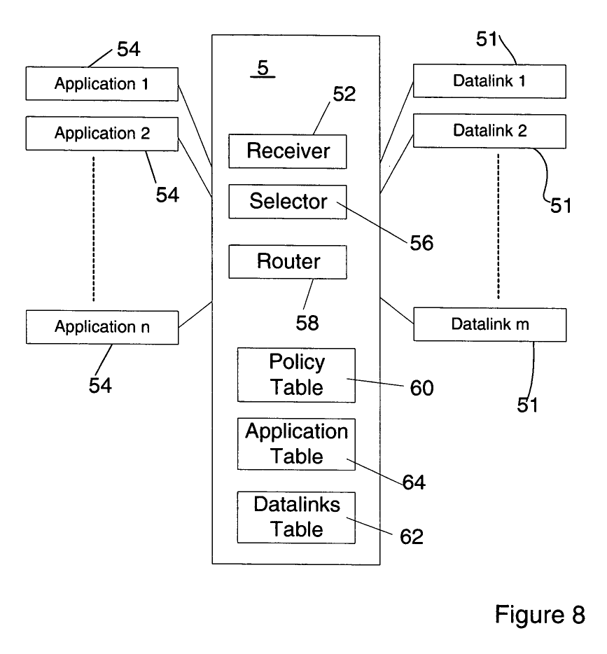

The Connection Gateway is connected to the various datalinks by appropriate onboard network adaptors of which at least one shall exist for every piece of computer hardware enabling communication over a given physical datalink (9). This is represented in the example shown in FIG. 2, which shows the Connection Gateway (5) listening to, or polling (6), network adaptors (7). (It should be noted that no assumptions are made as to how the physical communications devices are organised onboard the aircraft and also that the Connection Gateway may not necessarily poll the devices itself, but may rely on a device management system (8) to carry out this task. This is explained below. A more detailed representation of an exemplary connection gateway 5 is shown in FIG. 8, comprising a receiver 52 for receiving requests from one or more applications 54 on an aircraft to transmit data from that aircraft, a selector 56 for selecting a datalink from available datalinks on the aircraft. The selection of datalink is based on a predetermined set of rules optionally stored in a policy table 60. A router 58 then routes the data from the requesting application over a TCP-IP connection on the selected datalink. The precise manner of operation of the connection gateway will be explained below.

In an optional feature the Connection Gateway also manages connectivity to a software program running on a ground-based hardware platform referred to hereafter as the Aircraft Location Registry (25), an exemplary schematic of which is shown in FIG. 9. This maintains a record of the active connections for one or more aircraft. Each connecting device has a Logical Name associated therewith. The Aircraft Location Registry runtime maintains a list of currently active Policies, together with their points of attachment and associated attributes, including the current preferred (and therefore active) physical datalink associated with the Policy, the Service Provider for that datalink, any limitations on packet size for that datalink, and any associated datalink characteristics. This data is suitably stored in a table 72. Associated software and hardware 74 on the Aircraft Location Registry maintains the table up to date as will be explained below.

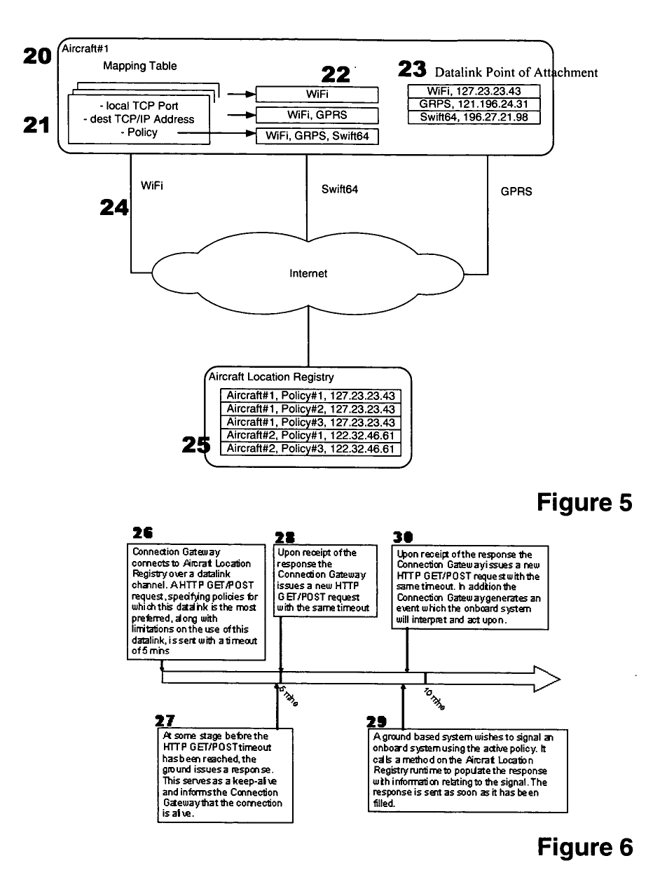

FIG. 5 shows an overall general schematic of the system. An exemplary aircraft (20) is shown, having stored onboard a Datalink Point of Attachment Table (23) containing the IP addresses that the aircraft has for each connected datalink (24). A Mapping Table (21) maps the port of an incoming application to a destination IP address and a Policy (22), which specifies the datalink over which this application should communicate. By mapping the preferred datalink for a given Policy to an address in the Datalink Point of Attachment table, the Connection Gateway can establish routes for traffic between the onboard application and the ground-based application with which it wishes to communicate. In addition the Aircraft Location Registry is shown, containing a table entry, per Policy, indicating the aircraft's IP address for the purposes of attachment to the aircraft using that Policy. We shall see later how the Connection Gateway and the Aircraft Location Registry update their internal state.

The Connection Gateway attaches and de-attaches from the Internet over various different communications datalinks. How this is achieved depends on the type of underlying datalink. By way of example, there are two broad categorisation of datalink for this purpose:
(1) For certain datalinks, it is forbidden to allow the hardware to remain powered up during particular phases of flight. In this case an onboard system may be responsible for managing the physical device such that the device shall only be powered up when the managing system has received notification (for example, through a Weight On Wheels (WOW) discrete or onboard data bus messages) that it is permissible to do so.

(2) Other datalinks are permissible at all phases of flight, but are not necessarily available at all stages. For example for satellite communications the onboard SDU may log on to and log off from a number of different Ground Earth Stations (GESs) during a particular flight segment.

In both cases, the device management systems (or Device Controllers (8)) will update their internal state. These internal states may be monitored by the Connection Gateway (either by polling the management system in question, or by receiving events, for example, through the onboard data bus).

Each time that the Connection Gateway becomes aware of the possibility of creation of a connection over a given datalink, it stores the IP address that it has been provided with by the datalink service provider in a Datalink Point of Attachment Table. Whenever connections are made or dropped by the Connection Gateway, it updates the Datalink Point of Attachment Table accordingly (11) (15). The use of the Datalink Point of Attachment Table enables the Connection Gateway to know where to route Policy-managed traffic.

Suitably, applications, which use the Connection Gateway to relay connectivity to the ground, are associated with Policies. These Policies specify the datalink channels over which individual applications are permitted to send data. The datalink channels for each Policy are ordered by preference such that the most preferred datalink is listed first, followed by the next most preferred, followed by the next most preferred, and so on (22). Policies are shared between air- and ground-based applications such that they are common to, and “understood” by, both air and ground. This means that all Policies are defined for both air-based and ground-based systems, and so when a ground application wishes to use a “Low Bandwidth, High Importance” Policy (for example), a corresponding air-based system will know exactly what this Policy is, because both systems have a definition of that Policy.

The Connection Gateway maintains awareness of the current highest preferred available datalink for all active Policies in the Policy Preference Table. The Policy Preference table contains a list of each Policy onboard the aircraft associated with its current most preferred communications datalink. A Policy becomes active when connectivity over one of its associated datalinks is possible (10). If a Policy is active, it will have a completed entry in the Policy Preference Table. A completed entry is one that refers to an active datalink.

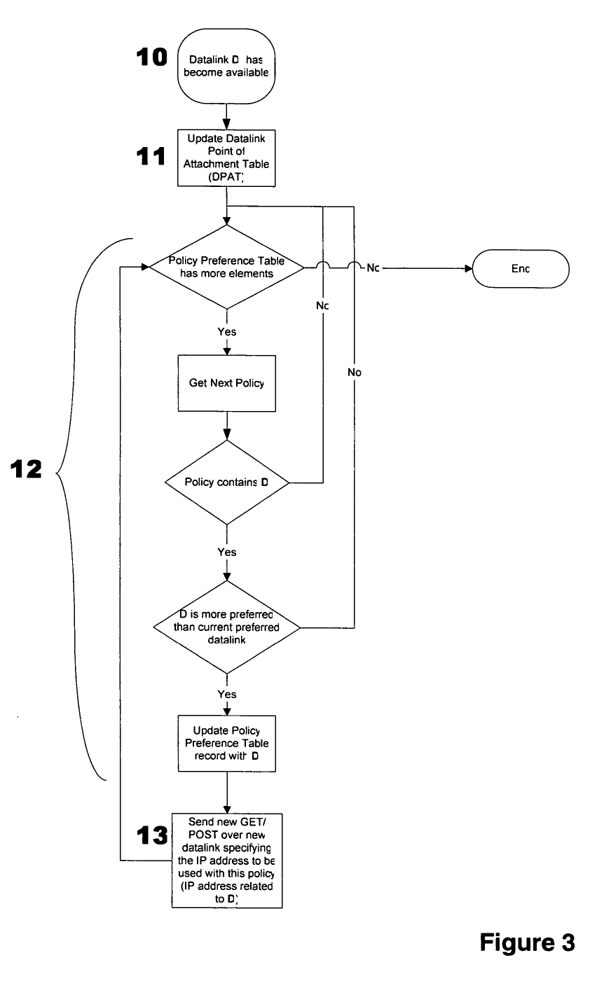

When a datalink becomes available (10), the Connection Gateway updates the Datalink Point of Attachment Table (11), and then iterates over each Policy in the Policy Preference Table (12) containing the datalink and checks to see if the newly available datalink is more preferred than the current datalink associated with the Policy. If it is more preferable, the Connection Gateway updates the Policy Preference Table entry to set the newly available datalink as the currently preferred datalink for that Policy. A new GET/POST (13) is sent to the Aircraft Location Registry relating to this Policy specifying the updated IP address of the aircraft for traffic using this Policy from the ground. If the newly available datalink is not more preferable, the entry is left as it was (12). This is illustrated in FIG. 3, which details a flowchart showing the main stages in the process of updating Policies when a datalink becomes available.

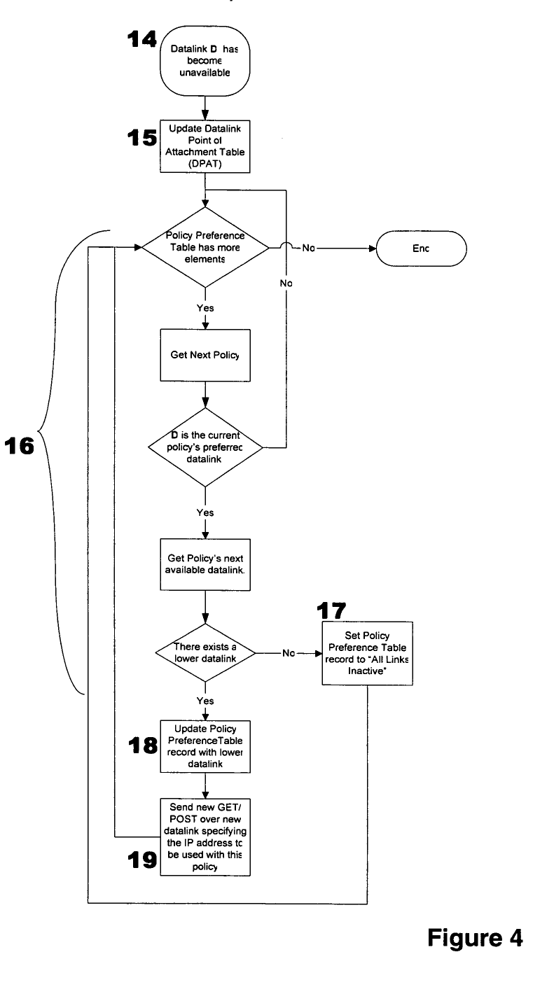

When a datalink becomes unavailable (14), the Connection Gateway updates the Datalink Point of Attachment Table (15), and then iterates over each Policy in the Policy Preference Table (16) for which the newly unavailable datalink is the preferred datalink and updates the preferred datalink to be the next available datalink (18). A new HTTP GET/POST (19) is sent to the Aircraft Location Registry relating to this Policy specifying the updated IP address of the aircraft for traffic using this Policy from the ground. If there is no lower datalink, or if there is no lower datalink available, the preferred datalink is set to be “All Links inactive” (17). This is illustrated in FIG. 4, which details a flowchart showing the main stages in the process of updating Policies when a datalink becomes unavailable.

The Connection Gateway also maintains a Mapping Table (21), which maps onboard applications to the IP address of their associated Policy's most preferred subnetwork IP address at the point where the application connected. Each entry in the Mapping Table includes the local TCP port and/or address of the application that is connecting to the ground through the Connection Gateway, the destination TCP/IP address of the ground application to which it is connecting, and the Policy governing communications by this application. The Connection Gateway acts as a relay for communications between the local (onboard) application and the ground-based application directing traffic from the on-board applications over the appropriate datalink and/or directing received data from the ground to the appropriate on-board application.

The Connection Gateway, when it receives an invocation from an onboard application seeking to establish a connection to a ground-based application, suitably consults the Policy associated with the air-based application to discover what communications datalink should be used. The Connection Gateway maintains a list of static associations between an onboard application and a Policy, the onboard application being identified by a TCP port and/or address. Also associated with the applications may be the TCP/IP address of their ground-based destinations. If one or more datalinks listed in the Policy are available, the Connection Gateway will connect to the ground-based application over the preferred datalink, by the inclusion of the selected datalink's IP address as the source address of the connection and the establishment of a Policy Based Route in the IP communications layer Routing Information Base (RIB), specifying that packets originating from this IP address and destined for the associated ground-based destination are forwarded over the appropriate datalink. This ensures that all packets associated with the connection are forwarded over the appropriate data link. The Connection Gateway then returns a success indication to the onboard application. All later invocations coming from the onboard application using this connection shall be relayed through the Connection Gateway to the IP address of the ground-based application.

As datalink channels become available the Connection Gateway may direct the Aircraft Location Registry to update its internal state to reflect changes to the preferred available datalink for a given Policy. It achieves this by issuing an updated HTTP primitive to the Aircraft Location Registry, specifying the new most preferred available datalink for the Policy (19) (26) (31).

The Connection Gateway is informed, or may discover, via the datalink management system whenever connectivity over a specified subnetwork is available. The Connection Gateway retrieves from the underlying subnetwork the assigned IP address indicating the Point of Attachment for the subnetwork. The Connection Gateway is informed, or may discover, via the datalink management system whenever the subnetwork is no longer available (27).

When connectivity to the ground, from an aircraft, over a particular datalink channel, becomes available, the aircraft registers itself with the Aircraft Location Registry (26). The Aircraft Location Registry contains, for each aircraft the preferred IP address to use to connect to that aircraft for each Policy active on board that aircraft. (25)

For example, consider the situation where the aircraft has three applications, each with a different associated Policy as follows:
Policy 1 allows for communication by WiFi first, followed by GPRS
Policy 2 allows only for communication by WiFi
Policy 3 allows for communication by WiFi first, followed by Swift64 MPDS

Consider a situation where only GPRS and Swift64 connections are available. If an application uses the Connection Gateway to connect to the ground using Policy 1, the Connection Gateway suitably selects the use of a GPRS connection as no WiFi connection is available. Upon connection, the Connection Gateway passes to the Aircraft Location Registry the IP address associated with the GPRS point of attachment. The aircraft shall be registered on the ground in the Aircraft Location Registry, wherein it shall be marked that, for a connection using Policy 1 to the aircraft, the provided (GPRS) IP address should be used. In addition, any constraints on the use of this connection are included, for example constraints on the maximum permissible block size which may be communicated, and so on.

Similarly, if an application connects to the ground using Policy 3, it would suitably select to use a Swift64 MPDS connection because of the lack of a WiFi connection. Upon connection, the Connection Gateway passes to the ground (Aircraft Location Register) the IP address associated with the Swift64 MPDS point of attachment. In addition, the aircraft may be registered on the ground in the Aircraft Location Registry, wherein it may be marked that, for a connection using Policy 3 to the aircraft, the provided (Swft64) IP address should be used. In addition, any constraints on the use of this connection are included, for example constraints on the maximum permissible block size which may be communicated, and so on.

In respect of Policy 2 connectivity, as there is no WiFi available, there is no available connection to the ground for any Policy 2 identified applications. To reflect this, either a null value or no entry may be made\entered in the Aircraft Location Registry with regard to Policy 2 connectivity, thus indicating that no connectivity is possible for ground applications wishing to communicate where these applications are associated with Policy 2. The Connection Gateway sends periodic HTTP “keepalive” (26)(31) primitives to the Aircraft Location Registry for each active Policy specifying the current most preferred point of attachment for that Policy. The Aircraft Location Registry is adapted to respond (27) to the keepalive primitives within a time interval specified in the primitive. If the Connection Gateway receives a response to the keepalive primitives, it knows that the datalink is still available. Similarly, by extension failure (33) to receive a response indicates that the datalink is no longer available. If the Aircraft Location Registry does not receive a renewed keepalive for that Policy before the expiry of the time interval will result in the Aircraft Location Registry purging the corresponding entry from its tables.

If we now consider the situation, for example, where WiFi connectivity becomes available, the Connection Gateway, in accordance with the exemplary Policies above, may now update its internal state to reflect that for applications communicating using Policies 1, 2, and 3, the preferred communication datalink is WiFi. Upon connection to the ground the Aircraft Location Registry is suitably updated to reflect the changes, that is, it is marked that, for a connection using Policy 1, 2, or 3 to the aircraft, the provided (WiFi) IP address should be used.

As the Aircraft Location Registry maintains an up to list of the status of connections available for an aircraft, it may be queried by applications on the ground or elsewhere to know what IP address should be used to communicate with an aircraft using a given Policy. Applications may also determine the type of datalink and/or characteristics of the datalink.

It will be appreciated that this provides possibilities for several applications, including for example:

A ground-based application, may query the Aircraft Location Registry before fulfilling a request by an onboard application to decide how best to send the response. This can be used, for example, in deciding how much information to send in a response, or for ordering or data-segmenting algorithms, such as those employed by Internet Download Managers to allow for incremental download of data over multiple connections.
The aircraft location register may be queried by third party applications to gather information about connectivity uptimes and used in IPDR reconciliations. An IPDR is an Internet Protocol Data Record, which is used to generate accounting information concerning Internet connectivity. The Aircraft Location Registry could generate events whenever it can infer that a given datalink has been initialised or dropped. An external application could listen to these events and update its records accordingly.
The aircraft location register may be used by ground-based data managers for a number of purposes including for example the scheduling of data upload/download retries, continuations, etc. For example, if a request for data was made by an air-based system and the transfer of that data was interrupted, and if furthermore there was in place a data manager on the ground which could schedule continuation of the interrupted transfer, the Aircraft Location Registry could be used by the said data manager to locate the IP address of the aircraft when connectivity was restored.
The aircraft location register may also be used by ground-based applications to signal the aircraft and, potentially, to send data up to it (provided suitable security provisions are provided). This would require the use of an interface to the ground based outstanding HTTP primitive processor (see below) in the Aircraft Location Registry whereby the HTTP primitive processor would be asked to formulated a special type of response to the outstanding GET/POST which would in effect be an event sent to an onboard system requesting that the said system “contact” the ground and sync its dataset therewith. By using this “entry point” to the Aircraft Location Registry as the sole means of signalling an aircraft, the security of requests being made to the aircraft is guaranteed.

Optionally, a further feature is that there is maintained between the air and the ground, for every active datalink, an outstanding HTTP GET/POST primitive to the Aircraft Location Registry. This provides a signalling channel through which the ground systems can send well-known requests to the air systems.

For every open connection that is currently active as the preferred connection for a given Policy on board the aircraft, a HTTP GET/POST primitive is periodically submitted by the Connection Gateway to the Aircraft Location Registry component on the ground. (26)(28)(30)(31) This primitive contains a list of Policies for which this is the preferred datalink, authentication information, and any constraints (such as maximum data block size) which apply to the link. The primitive has a timeout associated with it. Before that timeout has been reached, the ground must compose a response to the GET/POST. Normally this will take a standardised format whose only purpose is to inform the Connection Gateway that the connection is still alive (27). This is illustrated in FIG. 6.

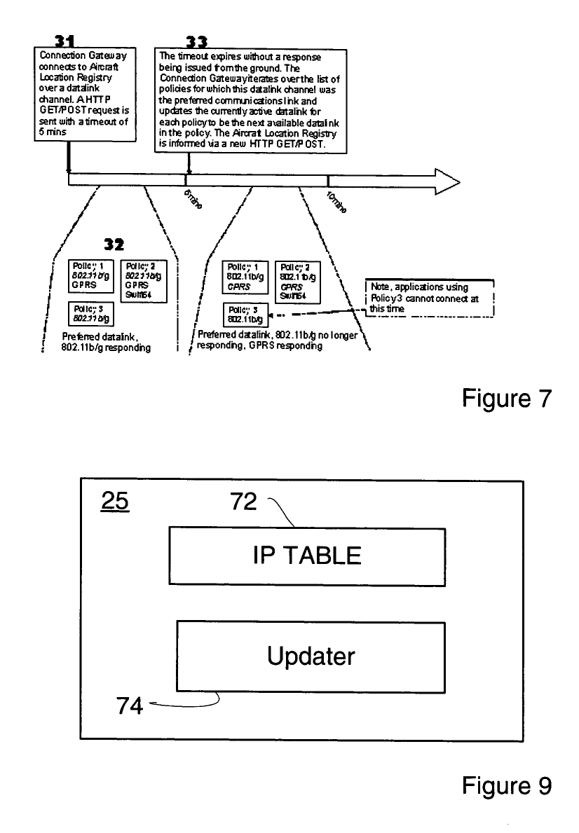

In an exemplary embodiment, if the Connection Gateway does not receive a response from the Aircraft Location Registry within the specified timeout (33), it may reattempt to make a connection up until a configured retry limit, after which it assumes that the connection is no longer alive and updates the Datalink Point of Attachment Table. The Connection Gateway then iterates over each of the Policies (32) in the Policy Preference Table as described earlier, and updates their state so that the current preferred datalink for each one is the next available datalink. (33) This is illustrated in FIG. 7.

It is not always desirable that an application remote to an aircraft should be able to directly invoke upon an application onboard that aircraft, in, for example, the same way as an Internet Client might invoke upon an Internet Server. It is more desirable that a ground-based application wishing to invoke upon an aircraft-located application should be required to go through a controlled gateway in order to make its invocation. The method of the Connection Gateway issuing an outstanding HTTP GET/POST serves to provide a mechanism whereby a system remote to an aircraft can communicate with a system on board that aircraft without the aircraft exposing a typical Internet Server style interface. Any application wishing to communicate with the aircraft must go through the Aircraft Location Registry and use a tightly controlled messaging method to make requests of the aircraft. This is described below.

If, at some point whilst an outstanding HTTP GET/POST is still active (i.e. not yet timed out and not yet responded to) a ground application wishes to signal an air-based application, it can do so by making a request on the Aircraft Location Registry runtime, specifying the signal it wishes to send. (29) The Aircraft Location Registry runtime shall populate a response to the GET/POST primitive with the information required to signal the onboard application and, as soon as the response has been filled, forward that response to the Connection Gateway. For example, additional information might be placed into the body of the HTTP response which, when received onboard the aircraft by the Connection Gateway, will result in a notification, for the attention of an onboard application, being created by the Connection Gateway, and the said notification being forwarded to that application, or, if no connectivity exists between the application and the Connection Gateway, the notification shall be stored and forwarded to the application when connectivity between the Gateway and the application is restored. The Connection Gateway shall generate the notification to be dealt with by the application in question and shall also upon receipt of the response, generate a new outstanding HTTP GET/POST (30). The existence of the outstanding HTTP GET/POST means that, for the duration of a connection over a physical datalink between the aircraft and the ground, the aircraft can be signalled, in a highly controlled fashion, from the ground, without ever exposing itself as a “server”. This helps to limit unauthorised attempts to attach to the aircraft, by requiring all invocations from ground-based systems to pass through the Aircraft Location Registry runtime, thereby enforcing the restriction that all TCP/IP connections are aircraft-initiated.

In the context of the present application, it will be appreciated by those skilled in the art that the means plus function language used may be readily implemented in software and/or hardware without undue burden or skill.

1. A Connection Gateway for an Aircraft, comprising:
a receiver for receiving requests from at least one application on the aircraft to transmit data from the aircraft,
a plurality of datalinks for transmitting data from the aircraft,
a selector for selecting a datalink from the plurality of datalinks using a predetermined set of rules,
a router for routing data from the at-least one application over a TCP/IP connection on the selected datalink.

2. A connection gateway according to claim 1, wherein said predetermined set of rules comprise a series of policies stored in a policy table.

3. A connection gateway according to claim 2, wherein said stored policies indicate the order of selection of the datalinks for each policy.

4. A connection gateway according to claim 2, wherein said predetermined set of rules includes a table mapping applications to individual policies, wherein the datalink is selected by determining the policy for a connecting application and then the highest preference datalink available for the determined policy

5. A connection gateway according to claim 4, wherein individual applications are identified in the table by the TCP port over which they connected to the connection gateway.

6. A connection gateway according to claim 4, wherein individual applications are identified by their IP address on the aircraft local network.

7. A connection gateway according to claim 4, wherein the connection gateway is adapted to determine the most appropriate datalink of currently available datalinks using the Policy associated with the application contained in the Policy table.

8. A connection gateway according to claim 1, wherein the connection gateway is adapted to store IP addresses assigned by Internet Service Providers as datalinks connect to them.

9. A connection gateway according to claim 8, wherein the connection gateway is adapted to store details of the datalink associated with each stored IP address.

10. A connection gateway according to claim 1 wherein the gateway is adapted to route data returning to an application on the aircraft from external applications through the same connection.

11. A connection gateway according to claim 1 further comprising means for informing an external application on the ground of the said connection gateway's currently assigned IP addresses for different Policies.

12. A connection gateway according to claim 11, wherein said means for informing an external application is also configured to inform the external application of the type of datalink being used by a policy.

13. A connection gateway according to claim 11, wherein said means for informing an external application is also configured to inform the external application of transmission parameters of datalinks being used by individual policies.

14. A connection gateway according to claim 13, wherein said transmission parameters may include the maximum permissible block size for transmission over the datalink.

15. A connection gateway according to claim 1, wherein the connection gateway is adapted to maintain a table listing available datalinks on the aircraft and their current status.

16. A connection gateway according to claim 1, wherein the connection gateway is adapted to maintain a list of onboard applications which may access the Connection Gateway.

17. A connection gateway according to claim 1, wherein the connection gateway is adapted to maintain a list of onboard applications actively connected to the connection gateway at any one time.

18. A connection Gateway according to claim 1, wherein the connection gateway is adapted to continuously monitor the status of all datalinks managed by it.

19. A connection gateway according to claim 18, wherein the connection gateway is adapted to query individual datalinks for datalink statistics.

20. A connection gateway according to claim 19, wherein said datalink statistics comprises one or more of the following: time connected, amount of data sent and errors.

21. A connection gateway according to claim 11, wherein the connection gateway is adapted to transmit a periodic http directive to the external application over the individual datalinks to test the availability of datalinks.

22. A connection gateway according to claim 21, wherein said periodic http directive comprises a ‘keepalive’ GET or POST primitives.

23. A connection gateway according to claim 21, wherein the connection gateway is adapted to alter the status of an individual datalink if a response is not received to an individual http directive within a predetermined time from the external application.

24. A connection gateway according to claim 21, wherein the periodic http directives are configured to be sent such that at any given instant there is an outstanding HTTP primitive on substantially all open aircraft datalinks to the external application.

25. A connection gateway according to claim 21, wherein the connection gateway is adapted to respond to triggers from the external application to request the initiation of data transmission to the aircraft to initiate a data transfer from the external application.

26. A method of operating a connection gateway on an Aircraft, comprising the steps of:
receiving requests from at least one application on the aircraft to transmit data from the aircraft,
selecting a datalink from a plurality of datalinks available on the aircraft using a predetermined set of rules,
routing data from the at-least one application over a TCP/IP connection on the selected datalink.

27. An Aircraft Location Registry comprising:
a table adapted to store IP addresses assigned by Internet Service Providers to individual datalinks on individual aircraft, and
an updater for updating said table in response to data received from individual aircraft.

28. An aircraft location registry according to claim 27, wherein said table is configured to hold an identifier for one or more communication policies for the individual aircraft and an associated IP address for each policy identified for an aircraft.

29. An aircraft location registry according to claim 27, wherein the updater is adapted to update the stored information concerning policies in response to data received from individual aircraft.

30. An aircraft location registry according to anyone of claims 27, wherein the table is further configured to store details of the type of datalink associated with an IP address.

31. An aircraft location registry according to claim 27 wherein the aircraft location registry is adapted to store transmission parameters of types of datalinks.

32. An aircraft location registry according to claim 31, wherein said transmission parameters may include the maximum permissible block size for transmission over the datalink.

33. An aircraft location registry according to claim 27, wherein the aircraft location registry is adapted to maintain a table listing available datalinks on individual aircraft and their current status.

34. An aircraft location registry according to claim 27 further adapted to receive and store datalink statistics for individual datalinks on individual aircraft.

35. An aircraft location registry according to claim 34 wherein the datalink statistics comprise one or more of the following: time connected, amount of data sent and errors.

36. An aircraft location registry according to 27, wherein the aircraft location registry is adapted to receive information from aircraft by means of http directives.

37. An aircraft location registry according to claim 36, wherein said aircraft location registry is adapted to respond to individual http directives to signal to individual aircraft of the availability of a particular datalink.

38. An aircraft location registry according to claim 37, wherein the aircraft location registry is adapted to delay for a given period before responding to individual http directives.

39. An aircraft location registry according to claim 37, wherein said periodic http directive comprises a ‘keepalive’ GET or POST primitives.

40. An aircraft location registry according to claim 37, wherein the aircraft location registry is adapted to include a trigger in a response to a http directive from an aircraft upon receipt of a request from another application to communicate with the aircraft.

41. A method of operating an aircraft location registry comprising the step of updating a table a table adapted to store IP addresses assigned by Internet Service Providers to individual datalinks on individual aircraft, in response to data received from individual aircraft.
